(19) United States
(12) Patent Application Publication
(10) Pub. No.: US 2024/0179640 A1
(43) Pub. Date: May 30, 2024

(54) ENHANCED POWER HEADROOM REPORT FOR MULTI-PANEL UE

(71) Applicant: Lenovo (Beijing) Limited, Beijing (CN)

(72) Inventors: Bingchao Liu, Beijing (CN); Lianhai Wu, Beijing (CN); Hongmei Liu, Beijing (CN); Haiming Wang, Beijing (CN); Zhi Yan, Beijing (CN)

(73) Assignee: Lenovo (Beijing) Limited, Beijing (CN)

(21) Appl. No.: 18/284,687

(22) PCT Filed: Apr. 2, 2021
(86) PCT No.: PCT/CN2021/085218

§ 371 Date: Sep. 28, 2023

(51) Int. Cl. H04W 52/36; H04L 5/00

(52) U.S. Cl. CPC H04W 52/365; H04L 5/0048

(57) ABSTRACT

Methods and apparatuses for power headroom report are disclosed. In one embodiment, a method comprises determining one or two PH values when power headroom report triggering condition is satisfied for a serving cell configured with two SRS resource sets used both for codebook based UL transmission or both for non-codebook based UL transmission; and transmitting the determined one or two PH values for the serving cell in one PHR MAC CE.

### FIELD

The subject matter disclosed herein generally relates to wireless communications, and more particularly relates to methods and apparatuses for enhanced power headroom report for multi-panel UE.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Power management Maximum Power Reduction (P-MPR), maximum permissible exposure (MPE), Power Headroom Report (PHR), Medium Access Control (MAC), MAC control element (MAC CE), logical channel ID (LCID), power headroom (PH), uplink shared channel (UL-SCH), Physical Uplink Shared Channel (PUSCH), Physical Uplink Control Channel (PUCCH), (E-UTRA), eNB NR Dual Connection (EN-DC), NR eNB Dual Connection (NE-DC), NG(Next Generation)-eNB NR Dual Connection (NGEN-DC), Sounding Reference Signal (SRS), frequency range 2 (FR2): indicating a frequency range of 24.25 GHZ˜52.6 GHZ, frequency range 1 (FR1): indicating a frequency range of 450 MHZ˜6 GHZ, Multiple panel UE (multi-panel UE, or MP-UE), transmission reception point (TRP), multiple TRP (multi-TRP or M-TRP), channel state information reference signal (CSI-RS), band width part (BWP), TS (Technical Specification) (TS refers to 3GPP Technical Specification in this disclosure), Transport Block (TB), Pathloss reference signal (PL-RS).

Power headroom (PH) is reported by UE to the gNB to indicate the power availability for UL transmission.

A Power Headroom Report (PHR) shall be triggered if phr-ProhibitTimer expires or has expired and the pathloss has changed more than phr-Tx-Power FactorChange dB for at least one activated Serving Cell of any MAC entity of which the active DL BWP is not dormant BWP which is used as a pathloss reference since the last transmission of a PHR in this MAC entity when the MAC entity has UL resources for new transmission. Note that the pathloss variation for one cell assessed above is between the pathloss measured at present time on the current pathloss reference and the pathloss measured at the transmission time of the last transmission of PHR on the pathloss reference in use at that time, irrespective of whether the pathloss reference has changed in between.

The PH is reported from the UE to the base station by sending a Single Entry PHR MAC CE or a Multiple Entry PHR MAC CE.

The Single Entry PHR MAC CE is identified by a MAC subheader with a dedicated LCID as specified in FIG. 1.

The Single Entry PHR MAC CE has a fixed size and consists of two octets defined as follows:

R: Reserved bit, set to 0.

Power Headroom (PH): This field indicates the power headroom level. The length of the field is 6 bits. The reported PH and the corresponding power headroom levels are shown in Table 1 (the corresponding measured values in dB are specified in 3GPP Technical Specification TS 38.133 V16.3.0). TS is an abbreviation for Technical Specification, and refers to 3GPP Technical Specification in the following description.

TABLE 1

| PH | Power Headroom Level |
|---|---|
| 0 | POWER_HEADROOM_0 |
| 1 | POWER_HEADROOM_1 |
| 2 | POWER_HEADROOM_2 |
| 3 | POWER_HEADROOM_3 |
| . . . | . . . |
| 60 | POWER_HEADROOM_60 |
| 61 | POWER_HEADROOM_61 |
| 62 | POWER_HEADROOM_62 |
| 63 | POWER_HEADROOM_63 |

Power Headroom (PH) has three types:

Type 1 power headroom: it refers to the difference between the nominal UE maximum transmit power and the estimated power for UL-SCH (uplink shared channel) transmission per activated serving cell. Type 1 power headroom for an activated serving cell may be calculated based on a reference PUSCH transmission. For example, for PUSCH transmission occasion i on active UL BWP b of carrier f of serving cell c, if the PUSCH is transmitted using PUSCH power control parameter set configuration with index j and PUSCH power control adjustment state with index l, the UE computes the Type 1 power headroom as

PH_{type1,b,f,c}(i,j,q_{d},l)=\tilde{P}_{CMAX,f,c}(i)−{P_{O_PUSCH,b,f,c}(j)+α_{b,f,c}(j)·PL_{b,f,c}(q_{d})+f_{b,f,c}(i,l)}[dB]

wherein, \tilde{P}_{CMAX,f,c}(i) is computed assuming MPR (which is allowed maximum power reduction)=0 dB, A-MPR (which is additional maximum power reduction)=0 dB, P-MPR=0 dB, and ΔT_{C} (which is allowed operating band edge transmission power relaxation)=0 dB, where MPR, A-MPR, P-MPR and ΔT_{C} are defined in TS 38.101-1, TS 38.101-2 and TS 38.101-3: the remaining parameters are defined in Clause 7.1.1 of TS 38.213 V16.3.0, where P_{O_PUSCH,b,f,c}(j) and α_{b,f,c}(j) are obtained using P_{O_NOMINAL_PUSCH,f,c}(0) and p0-PUSCH-AlphaSetId=0: PL_{b,f,c}(q) is obtained using pusch-PathlossReferenceRS-Id=0; and l=0.

Type 2 power headroom: it refers to the difference between the nominal UE maximum transmit power and the estimated power for UL-SCH and PUCCH transmission on SpCell of the other MAC entity (i.e. E-UTRA MAC entity in EN-DC (eNB NR Dual Connection), NE-DC (NR eNB Dual Connection), and NGEN-DC (Next Generation eNB NR Dual Connection) cases).

Type 3 power headroom: it refers to the difference between the nominal UE maximum transmit power and the estimated power for SRS (Sounding Reference Signal) transmission per activated Serving Cell. Type 3 power headroom for an activated serving cell may be calculated based on a reference SRS transmission. For example, for SRS transmission occasion i on UL BWP b of carrier f of serving cell c, and if the UE is not configured for PUSCH transmissions on UL BWP b of carrier f of serving cell c and a resource for the reference SRS transmission is provided by SRS-Resource, the UE computes a Type 3 power headroom report as

PH_{type3,b,f,c}(i,qₛ)=\tilde{P}_{CMAX,f,c}(i)−{P_{O_SRS,b,f,c}(qₛ)+α_{SRS,b,f,c}(qₛ)·PL_{b,f,c}(q_{d})+h_{b,f,c}(i)}[B]

wherein, qₛ is an SRS resource set corresponding to SRS-ResourceSetId=0 for UL BWP b: P_{O_SRSb,f,c}(qₛ), α_{SRS,f,c}(qₛ), PL_{b,f,c}(qₛ) and h_{b,f,c}(i) are defined in Clause 7.3.1 of TS 38.213 V16.3.0 with corresponding values obtained from SRS-ResourceSetId=0 for UL BWP b; \tilde{P}_{CMAX,f,c}(i) is computed assuming MPR=0 dB, A-MPR=0 dB, P-MPR=0 dB and ΔT_{C}=0 dB, where MPR, A-MPR, P-MPR and ΔT_{C} are defined in TS 38.101-1 V16.3.0, TS 38.101-2 V16.3.0 and TS 38.101-3 V16.3.0.

P: If a higher layer parameter mpe-Reporting-FR2, which is used to enable the MPE detection, is configured and the serving cell operates on FR2, the MAC entity shall set this field to 0 if the applied P-MPR value, to meet MPE requirements, as specified in TS 38.101-2 V16.3.0, is less than P-MPR_00 as specified in TS 38.133 V16.3.0 and to 1 otherwise. If mpe-Reporting-FR2 is not configured or the serving cell operates on FR1, this field indicates whether power backoff is applied due to power management. The MAC entity shall set the P field to 1 if the corresponding P_{CMAX,f,c} field would have had a different value if no power backoff due to power management had been applied.

P_{CMAX,f,c}: This field indicates the P_{CMAX,f,c} used for calculation of the preceding PH field. The reported P_{CMAX,f,c} and the corresponding nominal UE transmit power levels are shown in Table 2 (the corresponding measured values in dBm are specified in TS 38.133 V16.3.0).

TABLE 2

| P_{CMAX, f, c} | Nominal UE transmit power level |
|---|---|
| 0 | PCMAX_C_00 |
| 1 | PCMAX_C_01 |
| 2 | PCMAX_C_02 |
| . . . | . . . |
| 61 | PCMAX_C_61 |
| 62 | PCMAX_C_62 |
| 63 | PCMAX_C_63 |

MPE: Maximum permissible exposure (MPE) issue is defined in NR Release 16. The UE shall apply maximum output power reduction to ensure compliance with applicable electromagnetic power density exposure requirements and addressing unwanted emissions and/or self-defence requirements. It means that when MPE issue is detect, the UE may not have enough power for UL transmission due to maximum output power reduction. If mpe-Reporting-FR2 is configured, and the serving cell operates on FR2, and if the P field is set to 1, this field indicates the applied power backoff to meet MPE requirements, as specified in TS 38.101-2 V16.3.0. This field indicates an index to Table 3 and the corresponding measured values of P-MPR levels in dB are specified in TS 38.133 V16.3.0. The length of the field is 2 bits. If mpe-Reporting-FR2 is not configured, or if the Serving Cell operates on FR1, or if the P field is set to 0, R bits are present instead.

TABLE 3

| MPE | Measured P-MPR value |
|---|---|
| 0 | P-MPR_00 |
| 1 | P-MPR_01 |
| 2 | P-MPR_02 |
| 3 | P-MPR_03 |

The Multiple Entry PHR MAC CE is identified by a MAC subheader with dedicated LCID as specified in FIG. 2 or FIG. 3.

The Multiple Entry PHR MAC CE has a variable size, and includes the bitmap, a Type 2 PH field and an octet containing the associated P_{CMAX,f,c} field (if reported) for SpCell of the other MAC entity, a Type 1 PH field and an octet containing the associated P_{CMAX,f,c} field (if reported) for the PCell. It further includes, in ascending order based on the ServCellIndex, one or multiple of Type X PH fields and octets containing the associated P_{CMAX,f,c} fields (if reported) for Serving Cells other than PCell indicated in the bitmap. X is either 1 or 3 according to TS 38.213 V16.3.0 and TS 36.213 V16.3.0.

The presence of Type 2 PH field for SpCell of the other MAC entity is configured by setting higher layer parameter phr-Type2OtherCell with value true.

A single octet bitmap (see FIG. 2) is used for indicating the presence of PH per Serving Cell when the highest ServCellIndex of Serving Cell with configured uplink is less than 8, otherwise four octets are used (see FIG. 3).

The MAC entity determines whether PH value for an activated Serving Cell is based on real transmission or a reference format by considering the configured grant(s) and downlink control information which has been received until and including the PDCCH occasion in which the first UL grant for a new transmission that can accommodate the MAC CE for PHR as a result of LCP as defined in clause 5.4.3.1 of TS38.321 V16.3.0 is received since a PHR has been triggered if the PHR MAC CE is reported on an uplink grant received on the PDCCH or until the first uplink symbol of PUSCH transmission minus PUSCH preparation time as defined in clause 7.7 of TS 38.213 V16.3.0 if the PHR MAC CE is reported on a configured grant.

For a band combination in which the UE does not support dynamic power sharing, the UE may omit the octets containing Power Headroom field and P_{CMAX,f,c} field for Serving Cells in the other MAC entity except for the PCell in the other MAC entity and the reported values of Power Headroom and P_{CMAX,f,c} for the PCell are up to UE implementation.

The Multiple Entry PHR MAC CE includes the following fields: Cᵢ, R, V, Power Headroom (PH), P, P_{CMAX,f,c}, and MPE. Among these fields, the explanations of R, Power Headroom (PH), P, P_{CMAX,f,c}, and MPE are substantially the same as those field contained in the Single Entry PHR MAC CE. Accordingly, detailed explanations are omitted.

The explanations of Cᵢ and V fields are as follows:

Cᵢ: This field indicates the presence of a PH field for the Serving Cell with ServCellIndex i as specified in TS 38.331 V16.3.0. The Cᵢ field set to 1 indicates that a PH field for the Serving Cell with ServCellIndex i is reported. The Cᵢ field set to 0 indicates that a PH field for the Serving Cell with ServCellIndex i is not reported.

V: This field indicates if the PH value is based on a real transmission or a reference format. For Type 1 PH, the V field set to 0 indicates real transmission on PUSCH and the V field set to 1 indicates that a PUSCH reference format is used. For Type 2 PH, the V field set to 0 indicates real transmission on PUCCH and the V field set to 1 indicates that a PUCCH reference format is used. For Type 3 PH, the V field set to 0 indicates real transmission on SRS and the V field set to 1 indicates that an SRS reference format is used. Furthermore, for Type 1 PH, Type 2 PH, and Type 3 PH, the V field set to 0 indicates the presence of the octet containing the associated P_{CMAX,f,c} field and the MPE field, and the V field set to 1 indicates that the octet containing the associated P_{CMAX,f,c} field and the MPE field is omitted.

As a whole, when a PHR is triggered, the PH is reported by the UE by sending a Single Entry PHR MAC CE or a Multiple Entry PHR MAC CE.

For single panel UE in single-TRP scenario, single PH report for a serving cell is enough. However, it may not be efficient for multiple panel UE (multi-panel UE, i.e. MP-UE) that means UE equipped with multiple panels, especially for the UE that has multiple activated panels that can be used for UL transmission in multi-TRP scenario. For example, one DCI may schedule two PUSCH transmissions targeting two different TRPs from different panels in different time slots. If the UE only reports a single PHR to the gNB according to NR Release 16, the gNB can only obtain the power availability of one panel-TRP link. For a UE equipped with multiple panels, the panel status, i.e., activated or deactivated, maybe dynamically changed by the UE. A more efficient and flexible PHR reporting mechanism is required.

This disclosure targets the enhancement on the PHR reporting for MP-UE in multi-TRP scenario.

### BRIEF SUMMARY

Methods and apparatuses for power headroom report for multi-panel UE are disclosed.

In one embodiment, a method of a UE comprises determining one or two PH values when power headroom report triggering condition is satisfied for a serving cell configured with two SRS resource sets used both for codebook based UL transmission or both for non-codebook based UL transmission; and transmitting the determined one or two PH values for the serving cell in one PHR MAC CE. The serving cell has two TRPs, where each of the two SRS resource sets used both for codebook based UL transmission or both for non-codebook based UL transmission corresponds to a different one of the two TRPs.

In one embodiment, the power headroom report triggering condition is satisfied if a deactivated UE panel is activated, and one PH value corresponding to the activated UE panel is determined.

In another embodiment, a first phr-PeriodicTimer and a second phr-PeriodicTimer are configured on the serving cell, the first phr-PeriodicTimer is associated with a first TRP of the two TRPs, and the second phr-PeriodicTimer is associated with a second TRP of the two TRPs, when the first phr-PeriodicTimer expires, the PH value corresponding to the first TRP is determined, and when the second phr-PeriodicTimer expires, the PH value corresponding to the second TRP is determined. Alternatively, one phr-PeriodicTimer is configured on the serving cell, when the one phr-PeriodicTimer expires, two PH values corresponding to the two TRPs of the serving cell are determined.

In some embodiment, a phr-ProhibitTimer is configured on the serving cell, the first phr-Tx-PowerFactorChange is associated with a first PL-RS group, and the second phr-Tx-PowerFactorChange is associated with a second PL-RS group, when the phr-ProhibitTimer expires or has expired, and the pathloss measured within the first PL-RS group has changed more than the first phr-Tx-PowerFactorChange since the last transmission of the PH value corresponding to a first TRP of the two TRPs, the PH value corresponding to the first TRP is determined, and when the phr-ProhibitTimer expires or has expired, and the pathloss measured within the second PL-RS group has changed more than the second phr-Tx-Power FactorChange since the last transmission of the PH value corresponding to a second TRP of the two TRPs, the PH value corresponding to the second TRP is determined. Alternatively, a phr-ProhibitTimer is configured on the serving cell, a phr-Tx-PowerFactorChange is configured, the phr-Tx-PowerFactorChange is associated with both a first PL-RS group and a second PL-RS group, when the phr-ProhibitTimer expires or has expired, and the pathloss measured within the first PL-RS group has changed more than the phr-Tx-PowerFactorChange since the last transmission of the PH value corresponding to a first TRP of the two TRPs, the PH value corresponding to the first TRP is determined, and when the phr-ProhibitTimer expires or has expired, and the pathloss measured within the second PL-RS group has changed more than the phr-Tx-PowerFactorChange since the last transmission of the PH value corresponding to a second TRP of the two TRPs, the PH value corresponding to the second TRP is determined.

In some embodiment, a phr-ProhibitTimer is configured on the serving cell, a phr-Tx-PowerFactorChange is configured, when phr-ProhibitTimer expires or has expired, if the MAC entity has UL resources for new transmission with multi-beam repetition, and if the required power backoff due to power management corresponding to either a first TRP or a second TRP of the two TRPs has changed more than phr-Tx-PowerFactorChange since the last transmission of the PH value(s) when the MAC entity had UL resources for transmission with multi-beam repetition on at least one of the first TRP and the second TRP, the PH value corresponding to the first TRP and the PH value corresponding to the first TRP are determined. If one PH value was determined the last time, the one PH value is a reference PH value to be compared with the required power backoff due to power management: and if two PH values were determined the last time, one of the two PH values is determined as the reference PH value to be compared with the required power backoff due to power management. Alternatively, a phr-ProhibitTimer is configured on the serving cell, a first phr-Tx-PowerFactorChange and a second phr-Tx-PowerFactorChange are configured, when the phr-ProhibitTimer expires or has expired, if the MAC entity has UL resources for new transmission with multi-beam repetition, and if the required power backoff due to power management corresponding to a first TRP of the two TRPs has changed more than the first phr-Tx-PowerFactorChange since the last transmission of the PH value corresponding to the first TRP when the MAC entity had UL resources for transmission with multi-beam repetition on the first TRP, the PH value corresponding to the first TRP is determined, and when the phr-ProhibitTimer expires or has expired, if the MAC entity has UL resources for new transmission with multi-beam repetition, if the required power backoff due to power management corresponding to a second TRP of the two TRPs has changed more than the second phr-Tx-PowerFactorChange since the last transmission of the PH value corresponding to the second TRP when the MAC entity had UL resources for transmission with multi-beam repetition on the second TRP, the PH value corresponding to the second TRP is determined. Further alternatively, a phr-ProhibitTimer is configured on the serving cell, a phr-Tx-PowerFactorChange is configured, when the phr-ProhibitTimer expires or has expired, if the MAC entity has UL resources for new transmission with multi-beam repetition, and if the required power backoff due to power management corresponding to a first TRP of the two TRPs has changed more than the phr-Tx-PowerFactorChange since the last transmission of the PH value corresponding to the first TRP when the MAC entity had UL resources for transmission with multi-beam repetition on the first TRP, the PH value corresponding to the first TRP is determined, and when the phr-ProhibitTimer expires or has expired, if the MAC entity has UL resources for new transmission with multi-beam repetition, if the required power backoff due to power management corresponding to a second TRP of the two TRPs has changed more than the phr-Tx-PowerFactorChange since the last transmission of the PH value corresponding to the second TRP when the MAC entity had UL resources for transmission with multi-beam repetition on the second TRP, the PH value corresponding to the second TRP is determined.

In some embodiment, the one PHR MAC CE is a Single Entry PHR MAC CE that includes a bitmap with two bits, the i^{th} bit indicates the presence of a PH field for the i^{th} TRP of the serving cell, i is from 1 to 2. Alternatively, the one PHR MAC CE is a Multiple Entry PHR MAC CE that includes a bitmap with two bits, the i^{th} bit indicates the presence of a PH field for the i^{th} TRP of the serving cell, i is from 1 to 2.

In another embodiment, a UE comprises a processor that determines one or two PH values when power headroom report triggering condition is satisfied for a serving cell configured with two SRS resource sets used both for codebook based UL transmission or both for non-codebook based UL transmission: and a transmitter that transmits the determined one or two PH values in one PHR MAC CE.

In still another embodiment, a method of a base unit comprises receiving one or two PH values for a serving cell configured with two SRS resource sets used both for codebook based UL transmission or both for non-codebook based UL transmission in one PHR MAC CE, wherein the one PHR MAC CE includes a bitmap with two bits, each bit indicates the presence or absence of one PH value.

In yet another embodiment, a base unit comprises a receiver that receives one or two PH values for a serving cell configured with two SRS resource sets used both for codebook based UL transmission or both for non-codebook based UL transmission in one PHR MAC CE, wherein the one PHR MAC CE includes a bitmap with two bits, each bit indicates the presence or absence of one PH value.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a Single Entry PHR MAC CE;

FIG. 2 illustrates a Multiple Entry PHR MAC CE;

FIG. 3 illustrates another Multiple Entry PHR MAC CE;

FIG. 4 illustrates a multi-TRP scenario with multi-panel UE;

FIG. 5 illustrates a Single Entry PHR MAC CE according to the present disclosure;

FIG. 6 illustrates a Multiple Entry PHR MAC CE according to the present disclosure;

FIG. 7 is a schematic flow chart diagram illustrating an embodiment of a method;

FIG. 8 is a schematic flow chart diagram illustrating an embodiment of another method; and

FIG. 9 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

For a multiple panel UE (MP-UE, i.e. a UE equipped with multiple (e.g. M, where M>1) panels), one or more (e.g. L, where 1<=L<=M) of the multiple panels can be activated for DL reception and/or UL transmission. However, only one activated panel can be used for UL transmission at one time instant.

1. PHR reporting for panel switching:

The UE may deactivate one activated panel due to various reasons, e.g. when MPE event is detected. The UE may activate another previously inactive panel for UL transmission and/or DL reception.

When an inactive panel (or a deactivated panel) is switched to active status (that is, the inactive panel (or deactivated panel) is activated), PHR reporting corresponding to the activated panel is triggered.

For example, for a UE equipped with 3 panels in which only one panel is activated at a time instance while the other two panels are inactive (or deactivated) panels, if the current activated panel cannot be used for UL transmission due to UE rotation or MPE issue, the UE shall switch to another panel. It means that the UE will deactivate the current activated panel and activate one of previously inactive (or deactivated) panels. Upon the panel being activated, the UE shall report a PH value based on the newly activated panel to the gNB.

2. PHR reporting for multi-TRP PUSCH transmission:

It has been agreed that multi-TRP based PUSCH repetition will be supported in NR Release17. It has been also agreed to support per TRP power control for UL (e.g. PUSCH, SRS and PUCCH) transmission.

FIG. 4 illustrates a multi-TRP scenario in FR2, where a multi-panel UE is served by two TRPs (e.g. TRP #1 and TRP #2) of a serving cell in a same carrier. The serving cell is configured with two SRS resource sets used both for codebook based UL transmission or both for non-codebook based UL transmission. The UE is equipped with multiple panels and two (e.g. panel #1 and panel #2) out of the multiple panels are activated. Each activated panel can be used for DL reception as well as UL transmission for a certain TRP. However, only one activated panel can be used for UL transmission in one time slot due to power limitation.

The gNB transmits, through one TRP of a serving cell, a DCI scheduling a PUSCH transmission with repetition transmitted to multiple TRPs (e.g. two TRPs) of the serving cell in different time slots. For example, one TB is transmitted by PUSCH transmission #1 targeting TRP #1 in slot n from panel #1 and repeatedly transmitted by PUSCH transmission #2 targeting TRP #2 in slot n+1 from panel #2.

It can be seen that one radio link is formed between panel #1 and TRP #1, and another radio link is between panel #2 and TRP #2. In other words, the radio links between each panel and the TRP are different. Independent power controls (i.e. per TRP power control) for each of the panel-TRP radio links are maintained by the UE. It means that the UE may use different transmit powers determined by different power control parameter sets for the transmission of PUSCH transmission #1 from panel #1 to TRP #1 and for the transmission of PUSCH transmission #2 from panel #2 to TRP #2. Therefore, the UE may have different PH values for different activated panels. For example, the UE has a PH value (e.g. PH value 1) for panel #1 (i.e. for the radio link between panel #1 and TRP #1), and has another PH value (e.g. PH value 2) for panel #2 (i.e. for the radio link between panel #2 and TRP #2). Both PH values (e.g. PH value 1 and PH value 2) for different panels (or for different radio links) should be reported to the gNB.

Incidentally, it is not necessary that panel #1 is always linked to TRP #1 while panel #2 is always linked to TRP #2. Due to various reasons, e.g. UE rotation, the panel #1 may be linked to TRP #2 while the panel #2 may be linked to TRP #1. However, at any time, one activated panel is linked to one TRP while the other activated panel is linked to another TRP at least in FR2. In the following description, it is assumed that panel #1 is linked to TRP #1 while panel #2 is linked to TRP #2. In addition, TRP/panel or panel/TRP means a TRP and/or a panel where a radio link (or propagation link) is between the TRP and the panel.

As mentioned earlier, the serving cell is configured with two SRS resource sets used both for codebook based UL transmission or both for non-codebook based UL transmission. Each SRS resource set for codebook or non-codebook corresponds to a radio link between an activated panel and a TRP. For example, one of the two SRS resource sets for codebook or non-codebook can correspond to the radio link between panel #1 and TRP #1, while the other of the two SRS resource sets for codebook or non-codebook can correspond to the radio link between panel #2 and TRP #2. In addition, since the radio link between a panel and a TRP corresponds to the TRP, the one of the two SRS resource sets for codebook or non-codebook that corresponds to the radio link between panel #1 and TRP #1 also corresponds to TRP #1, while the other of the two SRS resource sets for codebook or non-codebook that corresponds to the radio link between panel #2 and TRP #2 also corresponds to TRP #2.

2.1 Periodic PHR reporting:

A periodic PHR reporting is triggered by a timer, e.g. configured by a RRC parameter phr-PeriodicTimer. Two options of triggering periodic PHR reporting are proposed.

Option 1 of triggering periodic PHR reporting:

TRP/panel-specific timer (e.g. phr-PeriodicTimer) can be configured for a UE. Each TRP/panel-specific timer is associated with one panel/TRP.

For example, phr-PeriodicTimer 1 and phr-PeriodicTimer2 are configured on the serving cell for the UE illustrated in FIG. 4, where phr-PeriodicTimer1 is associated with TRP #1/panel #1 and phr-PeriodicTimer2 is associated with TRP #2/panel #2. When phr-PeriodicTimer1 expires, the UE shall report the PH value corresponding to the radio link between panel #1 and TRP #1. When phr-PeriodicTimer2 expires, the UE shall report the PH value corresponding to the radio link between panel #2 and TRP #2.

Option 2 of triggering periodic PHR reporting:

A common phr-PeriodicTimer is configured. When the common phr-PeriodicTimer expires, PHR reporting corresponding to all activated panels is triggered. In this condition, the UE shall always report multiple PH values (e.g. two PH values corresponding to TRP #1/panel #1 and TRP #2/panel #2 respectively).

For example, one phr-PeriodicTimer is configured on the serving cell for the UE illustrated in FIG. 4. When phr-PeriodicTimer expires, the UE shall report the PH values corresponding to both TRP #1/panel #1 and TRP #2/panel #2 (i.e. both the radio link between panel #1 and TRP #1 and the radio link between panel #2 and TRP #2).

2.2 PHR reporting triggered by pathloss (PL) changing:

When a pathloss variation is more than a threshold (e.g. configured by RRC parameter phr-Tx-PowerFactorChange) and a prohibit timer (e.g. configured by phr-ProhibitTimer), that configures a minimum time duration within which PHR reporting is prohibited, expires or has expired, a PHR reporting will be triggered.

According to option 1 of triggering PHR reporting by pathloss changing of the present disclosure, TRP/panel-specific threshold (e.g. phr-Tx-PowerFactorChange) can be configured. Each TRP/panel-specific threshold is associated with one panel/TRP (i.e. with one panel-TRP link). In addition, a common prohibit timer (e.g. phr-ProhibitTimer) can be configured, although it is possible that TRP/panel-specific timers (e.g. phr-ProhibitTimer1 and phr-ProhibitTimer2) can be configured.

For example, phr-Tx-PowerFactorChange1 and phr-Tx-PowerFactorChange2 are configured on the serving cell for the UE illustrated in FIG. 4, where phr-Tx-PowerFactorChange1 is associated with TRP #1/panel #1 and phr-Tx-Power FactorChange2 is associated with TRP #2/panel #2. A common phr-ProhibitTimer is also configured on the serving cell for the UE illustrated in FIG. 4. In addition, two PL-RS groups (e.g. PL-RS group #1 and PL-RS group #2) are configured, where PL-RSs within each PL-RS group is associated with one TRP/panel. Note that a PL-RS indicates a DL RS used for pathloss estimation For example, if PL-RS group #1 consists of CSI-RS #1 and CSI-RS #2, and PL-RS group #2 consists of CSI-RS #3 and CSI-RS #4, then CSI-RS #1 and CSI-RS #2 within PL-RS group #1 can be associated with TRP #1/panel #1, and CSI-RS #3 and CSI-RS #4 within PL-RS group #2 can be associated with TRP #2/panel #2.

When phr-ProhibitTimer (or phr-ProhibitTimer 1) expires or has expired, if the pathloss measured within the PL-RS group #1 has changed more than phr-Tx-PowerFactorChange1 (i.e. pathloss variation #1 is more than phr-Tx-PowerFactorChange1) since the last transmission of the PH value corresponding to TRP #1/panel #1, the PH value corresponding to TRP #1/panel #1 is triggered to be reported.

In addition, when phr-ProhibitTimer (or phr-ProhibitTimer2) expires or has expired, if the pathloss measured within the PL-RS group #2 has changed more than phr-Tx-PowerFactorChange2 (i.e. pathloss variation #2 is more than phr-Tx-PowerFactorChange2) since the last transmission of the PH value corresponding to TRP #2/panel #2, the PH value corresponding to TRP #2/panel #2 is triggered to be reported.

The pathloss variation (e.g. the pathloss variation #1 or the pathloss variation #2) is assessed between the pathloss measured at present time on the current pathloss reference and the pathloss measured at the transmission time of the last transmission of PH on the pathloss reference in use at that time, irrespective of whether the pathloss reference has changed in between. However, the PL-RS used for comparison should be within a same PL-RS group.

For example, the pathloss variation #1 may be assessed between the pathloss measured at present time on the current pathloss reference (e.g. CSI-RS #1 or CSI-RS #2 of PL-RS group #1) and the pathloss measured at the transmission time of the last transmission of PHR on the pathloss reference in use at that time (e.g. CSI-RS #1 or CSI-RS #2 of the same PL-RS group #1, but not CSI-RS #3 or CSI-RS #4 of another PL-RS group (e.g. PL-RS group #2)).

According to option 2 of triggering PHR reporting by pathloss changing of the present disclosure, one threshold (e.g. phr-Tx-PowerFactorChange) is configured, and the one threshold (e.g. phr-Tx-PowerFactorChange) is associated with both TRP #1/panel #1 and TRP #2/panel #2. In addition, a common phr-ProhibitTimer is also configured on the serving cell for the UE illustrated in FIG. 4, although it is possible that TRP/panel-specific timers (e.g. phr-ProhibitTimer1 and phr-ProhibitTimer2) can be configured. In addition, two PL-RS groups (e.g. PL-RS group #1 consisting of CSI-RS #1 and CSI-RS #2, and PL-RS group #2 consisting of CSI-RS #3 and CSI-RS #4) are configured, where PL-RSs within each PL-RS group is associated with one TRP/panel (e.g. CSI-RS #1 and CSI-RS #2 within PL-RS group #1 are associated with TRP #1/panel #1, and CSI-RS #3 and CSI-RS #4 within PL-RS group #2 are associated with TRP #2/panel #2.

When phr-ProhibitTimer (or phr-ProhibitTimer1) expires or has expired, if the pathloss measured within the PL-RS group #1 has changed more than phr-Tx-PowerFactorChange (i.e. pathloss variation #1 is more than phr-Tx-PowerFactorChange) since the last transmission of the PH value corresponding to TRP #1/panel #1, the PH value corresponding to TRP #1/panel #1 is triggered to be reported.

In addition, when phr-ProhibitTimer (or phr-ProhibitTimer2) expires or has expired, if the pathloss measured within the PL-RS group #2 has changed more than phr-Tx-PowerFactorChange (i.e. pathloss variation #2 is more than phr-Tx-PowerFactorChange) since the last transmission of the PH value corresponding to TRP #2/panel #2, the PH value corresponding to TRP #2/panel #2 is triggered to be reported.

Similar to option 1, the pathloss variation (e.g. the pathloss variation #1 or the pathloss variation #2) is assessed between the pathloss measured at present time on the current pathloss reference and the pathloss measured at the transmission time of the last transmission of PH on the pathloss reference in use at that time, irrespective of whether the pathloss reference has changed in between. However, the PL-RS used for comparison should be within a same PL-RS group.

2.3 PHR reporting triggered by new UL transmission:

A common prohibit timer (e.g. phr-ProhibitTimer) can be configured, although it is possible that TRP/panel-specific prohibit timers (e.g. phr-ProhibitTimer1 and phr-ProhibitTimer2) can be configured.

When the MAC entity has UL resources for new transmission and the phr-ProhibitTimer expires or has expired, one or two PH values shall be triggered to be reported. The MAC entity having UL resources for new transmission means that there are new PUSCH resources or SRS resources allocated for transmission with multi-beam repetition or there is a new PUCCH transmission with multi-beam repetition on at least one of two TRPs of the serving cell.

Option 1 of PHR reporting triggered by new UL transmission:

Only one phr-Tx-PowerFactorChange is configured.

When the phr-ProhibitTimer expires or has expired, if (1) the MAC entity has UL resources for new transmission: and (2) the required power backoff due to power management for at least one of the two TRPs of the serving cell has changed more than phr-Tx-PowerFactorChange dB since the last transmission of the PH value(s) when the MAC entity had UL resources for transmission on at least one of the two TRPs of the serving cell, two PH values corresponding to the both TRPs (e.g. TRP #1 and TRP #2) (i.e. corresponding to TRP #1/panel #1 and TRP #2/panel #2) are reported. The reference PH for comparison with the required power backoff due to power management is determined as follows: if one PH value is reported the last time, the one PH value is the reference PH: and if two PH values are reported the last time, the UE takes one of the last reported PHs, e.g., the first reported PH, or the second reported PH, or the larger one of the last reported PHs, or the smaller one of the last reported PHs, as the reference PH.

As a whole, according to Option 1 of PHR reporting triggered by new UL transmission, two PH values corresponding to both TRPs of the serving cell (i.e. corresponding to both panel-TRP links) are always reported.

Option 2 of PHR reporting triggered by new UL transmission:

Two phr-Tx-PowerFactorChange parameters (e.g. phr-Tx-PowerFactorChange1 and phr-Tx-Power FactorChange2) are configured.

When the phr-ProhibitTimer expires or has expired, if (1) the MAC entity has UL resources for new transmission: and (2) the required power backoff due to power management corresponding to the one TRP (e.g. TRP #1) of the serving cell has changed more than phr-Tx-PowerFactorChange1 since the last transmission of the PH value corresponding to the one TRP (e.g. TRP #1) when the MAC entity had UL resources for transmission on the one TRP (e.g. TRP #1), the PH value corresponding to TRP #1/panel #1 (i.e. corresponding to panel #1-TRP #1 link) is triggered to be reported.

On the other hand, when the phr-ProhibitTimer expires or has expired, if (1) the MAC entity has UL resources for new transmission: and (2) the required power backoff due to power management corresponding to the other TRP (e.g. TRP #2) of the serving cell has changed more than phr-Tx-PowerFactorChange2 since the last transmission of the PH value corresponding to the other TRP (e.g. TRP #2) when the MAC entity had UL resources for transmission on the other TRP (e.g. TRP #2), the PH value corresponding to TRP #2/panel #2 (i.e. corresponding to panel #2-TRP #2 link) is triggered to be reported.

As a whole, according to Option 2 of PHR reporting triggered by new UL transmission, one or two PH values are reported.

Option 3 of PHR reporting triggered by new UL transmission:

One phr-Tx-PowerFactorChange (e.g. phr-Tx-PowerFactorChange) is configured.

When the phr-ProhibitTimer expires or has expired, if (1) the MAC entity has UL resources for new transmission: and (2) the required power backoff due to power management corresponding to the one TRP (e.g. TRP #1) of the serving cell has changed more than phr-Tx-PowerFactorChange since the last transmission of the PH value corresponding to the one TRP (e.g. TRP #1) when the MAC entity had UL resources for transmission on the one TRP (e.g. TRP #1), the PH value corresponding to TRP #1/panel #1 (i.e. corresponding to panel #1-TRP #1 link) is triggered to be reported.

On the other hand, when the phr-ProhibitTimer expires or has expired, if (1) the MAC entity has UL resources for new transmission: and (2) the required power backoff due to power management corresponding to the other TRP (e.g. TRP #2) of the serving cell has changed more than phr-Tx-PowerFactorChange since the last transmission of the PH value corresponding to the other TRP (e.g. TRP #2) when the MAC entity had UL resources for transmission on the other TRP (e.g. TRP #2), the PH value corresponding to TRP #2/panel #2 (i.e. corresponding to panel #2-TRP #2 link) is triggered to be reported.

3. Enhancements on PHR MAC CE:

As described above, one or two PH values (corresponding to one or two TRPs of a serving cell) may be reported for the serving cell if independent power control is configured for different panel-TRP links. The PHR MAC CE (Single Entry PHR MAC CE or Multiple Entry PHR MAC CE) is necessary to be enhanced to support reporting two PH values for one serving cell.

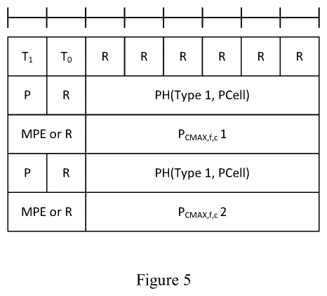

If the higher layer parameter multiplePHR (which is used to configures the UE to report the PHR using Single Entry PHR MAC CE or Multiple Entry PHR MAC CE) with value false is configured, and when independent power control for different panel-TRP links is configured for the PCell, the Single Entry PHR MAC CE according to present disclosure is illustrated in FIG. 5.

Compared with legacy Single Entry PHR MAC CE illustrated in FIG. 1, additional Tᵢ field is introduced. In addition, up to two PH values (i.e. one or two PH values) can be reported for the PCell. The following fields are included in the Single Entry PHR MAC CE according to present disclosure:

Tᵢ (i is from 0 to 1): This field indicates the present of the PH field for the i^{th} panel-TRP link. The Tᵢfield set to 1 indicates that a PH field for the i^{th} panel-TRP link of the PCell is reported. The Tᵢfield set to 0 indicates that a PH field for the i^{th} panel-TRP link of the PCell is not reported.

Power Headroom (PH) (this field is the same as the Power Headroom (PH) field of the legacy Single Entry PHR MAC CE): This field indicates the power headroom level.

P (this field is the same as the P field of the legacy Single Entry PHR MAC CE): If a higher layer parameter mpe-Reporting-FR2 is configured and the Serving Cell operates on FR2, the MAC entity shall set this field to 0 if the applied P-MPR value, to meet MPE requirements, as specified in TS 38.101-2 V16.3.0, is less than P-MPR_00 as specified in TS 38.133 V16.3.0 and to 1 otherwise. If mpe-Reporting-FR2 is not configured or the Serving Cell operates on FR1, this field indicates whether power backoff is applied due to power management. The MAC entity shall set the P field to 1 if the corresponding P_{CMAX,f,c} field would have had a different value if no power backoff due to power management had been applied.

P_{CMAX,f,c} (this field is the same as the P_{CMAX,f,c} field of the legacy Single Entry PHR MAC CE): This field indicates the P_{CMAX,f,c} used for calculation of the preceding PH field.

MPE (this field is the same as the MPE field of the legacy Single Entry PHR MAC CE): If mpe-Reporting-FR2 is configured, and the Serving Cell operates on FR2, and if the P field is set to 1, this field indicates the applied power backoff to meet MPE requirements. If mpe-Reporting-FR2 is not configured, or if the Serving Cell operates on FR1, or if the P field is set to 0, R bits are present instead.

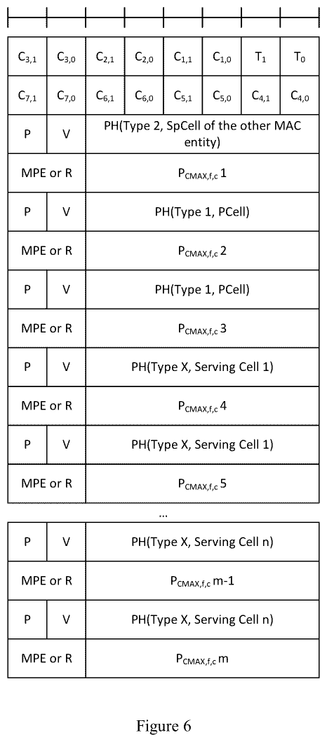

If multiplePHR with value true is configured, and when independent power control for different panel-TRP links is configured for the serving cell, the Multiple Entry PHR MAC CE according to present disclosure is illustrated in FIG. 6. The Multiple Entry PHR MAC CE illustrated in FIG. 6 is used when up to 8 serving cells (including one PCell) are configured with uplink.

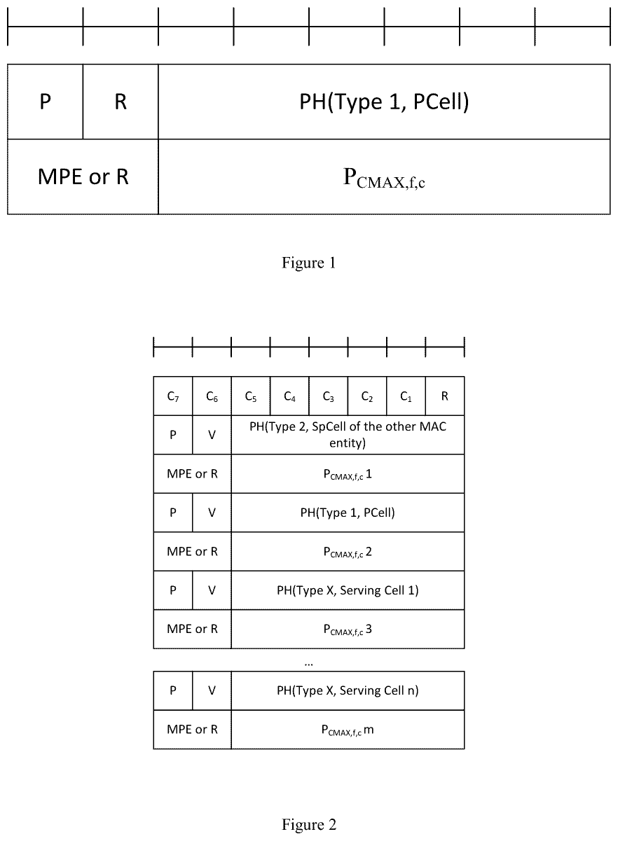

Compared with the legacy Multiple Entry PHR MAC CE illustrated in FIG. 2, additional Tᵢ (i is from 0 to 1) field is introduced in the Multiple Entry PHR MAC CE according to present disclosure. In addition, the Cᵢ field is replaced by C_{i,j} (i is from 1 to 7, j is from 0 to 1) field. Moreover, up to two PH values (i.e. one or two PH values) can be reported for each Serving Cell (including the PCell). In particular, one or two Type 1 PH fields (each of which is associated with an octet containing P_{CMAX,f,c} field (if reported) for the PCell) are contained depending on the Tᵢ field. One or multiple of Type X (X is 1 or 2 or 3) PH fields (each of which is associated with an octet containing the P_{CMAX,f,c} field (if reported) for a Serving Cell other than the PCell) are contained depending on the C_{i,j} field. The following fields are included in the Multiple Entry PHR MAC CE according to present disclosure:

Tᵢ (i is from 0 to 1): This field indicates the present of the PH field for the i^{th} panel-TRP link of PCell. The Tᵢ field set to 1 indicates that a PH field for the i^{th} panel-TRP link of the PCell is reported. The Tᵢ field set to 0 indicates that a PH field for the i^{th} panel-TRP link of the PCell is not reported.

C_{i,j} (i is from 1 to 7, j is from 0 to 1): This field indicates the presence of a PH field for the j^{th} panel-TRP link of Serving Cell with ServCellIndex i. The C_{i,j} field set to 1 indicates that a PH field for the j^{th} panel-TRP link of Serving Cell with ServCellIndex i is reported. The C_{i,j} field set to 0 indicates that a PH field for the j^{th} panel-TRP link of Serving Cell with ServCellIndex i is not reported.

V (this field is the same as the V field of the legacy Multiple Entry PHR MAC CE): this field indicates if the PH value is based on a real transmission or a reference format. The V field set to 0 indicates real PUSCH or PUCCH or SRS transmission and the V field set to 1 indicates that a PUSCH or PUCCH or SRS reference format is used for Type 1 or Type 2 or Type 3 PH. Furthermore, for Type 1, Type 2, and Type 3 PH, the V field set to 0 indicates the presence of the octet containing the associated P_{CMAX,f,c} field and the MPE field, and the V field set to 1 indicates that the octet containing the associated P_{CMAX,f,c} field and the MPE field is omitted.

Power Headroom (PH) (this field is the same as the Power Headroom (PH) field of the legacy Multiple Entry PHR MAC CE): This field indicates the power headroom level.

P (this field is the same as the P field of the legacy Multiple Entry PHR MAC CE): If a higher layer parameter mpe-Reporting-FR2 is configured and the Serving Cell operates on FR2, the MAC entity shall set this field to 0 if the applied P-MPR value, to meet MPE requirements, as specified in TS 38.101-2 V16.3.0, is less than P-MPR_00 as specified in TS 38.133 V16.3.0 and to 1 otherwise. If mpe-Reporting-FR2 is not configured or the Serving Cell operates on FR1, this field indicates whether power backoff is applied due to power management. The MAC entity shall set the P field to 1 if the corresponding P_{CMAX,f,c} field would have had a different value if no power backoff due to power management had been applied.

P_{CMAX,f,c} (this field is the same as the P_{CMAX,f,c} field of the legacy Multiple Entry PHR MAC CE): This field indicates the P_{CMAX,f,c} used for calculation of the preceding PH field.

MPE (this field is the same as the MPE field of the legacy Multiple Entry PHR MAC CE): If mpe-Reporting-FR2 is configured, and the Serving Cell operates on FR2, and if the P field is set to 1, this field indicates the applied power backoff to meet MPE requirements. If mpe-Reporting-FR2 is not configured, or if the Serving Cell operates on FR1, or if the P field is set to 0, R bits are present instead.

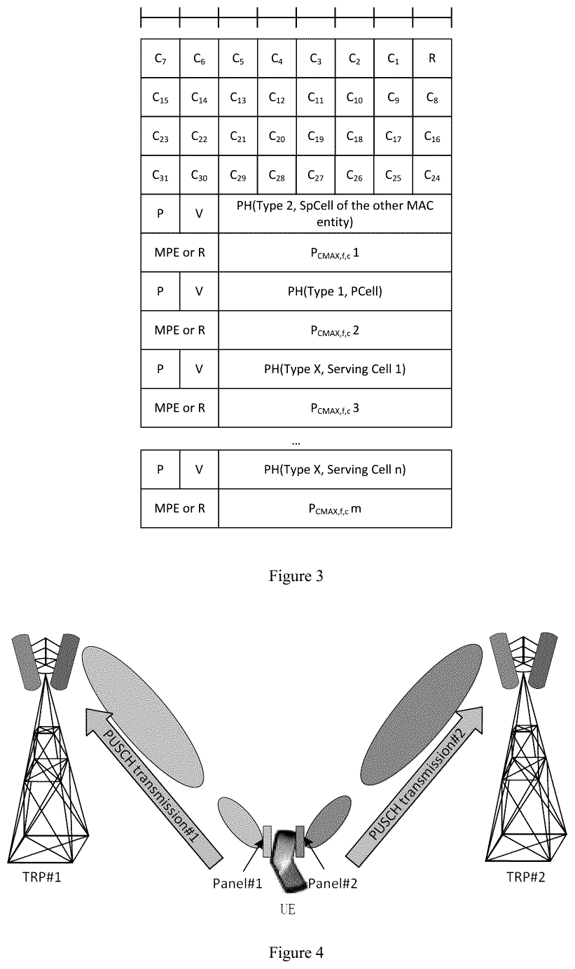

If more than 8 (e.g. from 9 to 32) serving cells (including one PCell) are configured with uplink, the legacy Multiple Entry PHR MAC CE illustrated in FIG. 3 can be enhanced to a Multiple Entry PHR MAC CE according to the present disclosure with the same manner as described above. In particular, additional Tᵢ (i is from 0 to 1) field is introduced, and the Cᵢ field shown in FIG. 3 is replaced by C_{i,j} (i is from 1 to 31, j is from 0 to 1) field. Similarly, up to two PH values (i.e. one or two PH values) can be reported for each Serving Cell (including the PCell).

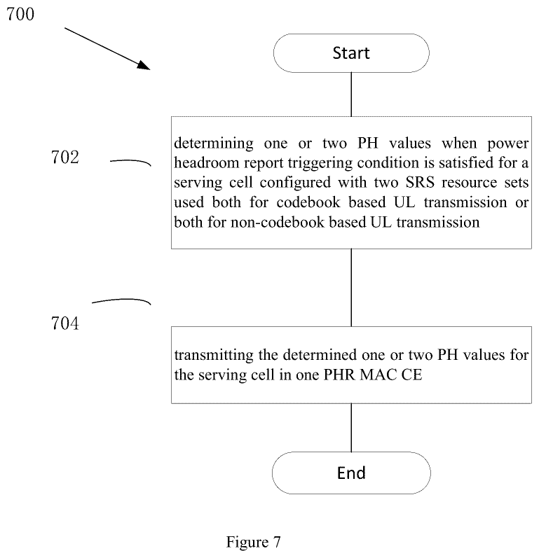

FIG. 7 is a schematic flow chart diagram illustrating an embodiment of a method 700 according to the present application. In some embodiments, the method 700 is performed by an apparatus, such as a remote unit (e.g. UE). In certain embodiments, the method 700 may be performed by a processor executing program code, for example, a microcontroller, a microprocessor, a CPU, a GPU, an auxiliary processing unit, a FPGA, or the like.

The method 700 is a method of a UE, comprising: 702 determining one or two PH values when power headroom report triggering condition is satisfied for a serving cell configured with two SRS resource sets used both for codebook based UL transmission or both for non-codebook based UL transmission: and 704 transmitting the determined one or two PH values for the serving cell in one PHR MAC CE. The serving cell has two TRPs, where each of the two SRS resource sets used both for codebook based UL transmission or both for non-codebook based UL transmission corresponds to a different one of the two TRPs.

In one embodiment, the power headroom report triggering condition is satisfied if a deactivated UE panel is activated, and one PH value corresponding to the activated UE panel is determined.

In another embodiment, a first phr-PeriodicTimer and a second phr-PeriodicTimer are configured on the serving cell, the first phr-PeriodicTimer is associated with a first TRP of the two TRPs, and the second phr-PeriodicTimer is associated with a second TRP of the two TRPs, when the first phr-PeriodicTimer expires, the PH value corresponding to the first TRP is determined, and when the second phr-PeriodicTimer expires, the PH value corresponding to the second TRP is determined. Alternatively, one phr-PeriodicTimer is configured on the serving cell, when the one phr-PeriodicTimer expires, two PH values corresponding to the two TRPs of the serving cell are determined.

In some embodiment, a phr-ProhibitTimer is configured on the serving cell, the first phr-Tx-Power FactorChange is associated with a first PL-RS group, and the second phr-Tx-PowerFactorChange is associated with a second PL-RS group, when the phr-ProhibitTimer expires or has expired, and the pathloss measured within the first PL-RS group has changed more than the first phr-Tx-PowerFactorChange since the last transmission of the PH value corresponding to a first TRP of the two TRPs, the PH value corresponding to the first TRP is determined, and when the phr-ProhibitTimer expires or has expired, and the pathloss measured within the second PL-RS group has changed more than the second phr-Tx-Power FactorChange since the last transmission of the PH value corresponding to a second TRP of the two TRPs, the PH value corresponding to the second TRP is determined. Alternatively, a phr-ProhibitTimer is configured on the serving cell, a phr-Tx-PowerFactorChange is configured, the phr-Tx-PowerFactorChange is associated with both a first PL-RS group and a second PL-RS group, when the phr-ProhibitTimer expires or has expired, and the pathloss measured within the first PL-RS group has changed more than the phr-Tx-PowerFactorChange since the last transmission of the PH value corresponding to a first TRP of the two TRPs, the PH value corresponding to the first TRP is determined, and when the phr-ProhibitTimer expires or has expired, and the pathloss measured within the second PL-RS group has changed more than the phr-Tx-PowerFactorChange since the last transmission of the PH value corresponding to a second TRP of the two TRPs, the PH value corresponding to the second TRP is determined.

In some embodiment, a phr-ProhibitTimer is configured on the serving cell, a phr-Tx-PowerFactorChange is configured, when phr-ProhibitTimer expires or has expired, if the MAC entity has UL resources for new transmission with multi-beam repetition, and if the required power backoff due to power management corresponding to either a first TRP or a second TRP of the two TRPs has changed more than phr-Tx-PowerFactorChange since the last transmission of the PH value(s) when the MAC entity had UL resources for transmission with multi-beam repetition on at least one of the first TRP and the second TRP, the PH value corresponding to the first TRP and the PH value corresponding to the first TRP are determined. If one PH value was determined the last time, the one PH value is a reference PH value to be compared with the required power backoff due to power management: and if two PH values were determined the last time, one of the two PH values is determined as the reference PH value to be compared with the required power backoff due to power management. Alternatively, a phr-ProhibitTimer is configured on the serving cell, a first phr-Tx-PowerFactorChange and a second phr-Tx-PowerFactorChange are configured, when the phr-ProhibitTimer expires or has expired, if the MAC entity has UL resources for new transmission with multi-beam repetition, and if the required power backoff due to power management corresponding to a first TRP of the two TRPs has changed more than the first phr-Tx-PowerFactorChange since the last transmission of the PH value corresponding to the first TRP when the MAC entity had UL resources for transmission with multi-beam repetition on the first TRP, the PH value corresponding to the first TRP is determined, and when the phr-ProhibitTimer expires or has expired, if the MAC entity has UL resources for new transmission with multi-beam repetition, if the required power backoff due to power management corresponding to a second TRP of the two TRPs has changed more than the second phr-Tx-PowerFactorChange since the last transmission of the PH value corresponding to the second TRP when the MAC entity had UL resources for transmission with multi-beam repetition on the second TRP, the PH value corresponding to the second TRP is determined. Further alternatively, a phr-ProhibitTimer is configured on the serving cell, a phr-Tx-PowerFactorChange is configured, when the phr-ProhibitTimer expires or has expired, if the MAC entity has UL resources for new transmission with multi-beam repetition, and if the required power backoff due to power management corresponding to a first TRP of the two TRPs has changed more than the phr-Tx-PowerFactorChange since the last transmission of the PH value corresponding to the first TRP when the MAC entity had UL resources for transmission with multi-beam repetition on the first TRP, the PH value corresponding to the first TRP is determined, and when the phr-ProhibitTimer expires or has expired, if the MAC entity has UL resources for new transmission with multi-beam repetition, if the required power backoff due to power management corresponding to a second TRP of the two TRPs has changed more than the phr-Tx-PowerFactorChange since the last transmission of the PH value corresponding to the second TRP when the MAC entity had UL resources for transmission with multi-beam repetition on the second TRP, the PH value corresponding to the second TRP is determined.

In some embodiment, the one PHR MAC CE is a Single Entry PHR MAC CE that includes a bitmap with two bits, the i^{th} bit indicates the presence of a PH field for the i^{th} TRP of the serving cell, i is from 1 to 2. Alternatively, the one PHR MAC CE is a Multiple Entry PHR MAC CE that includes a bitmap with two bits, the i^{th} bit indicates the presence of a PH field for the i^{th} TRP of the serving cell, i is from 1 to 2.

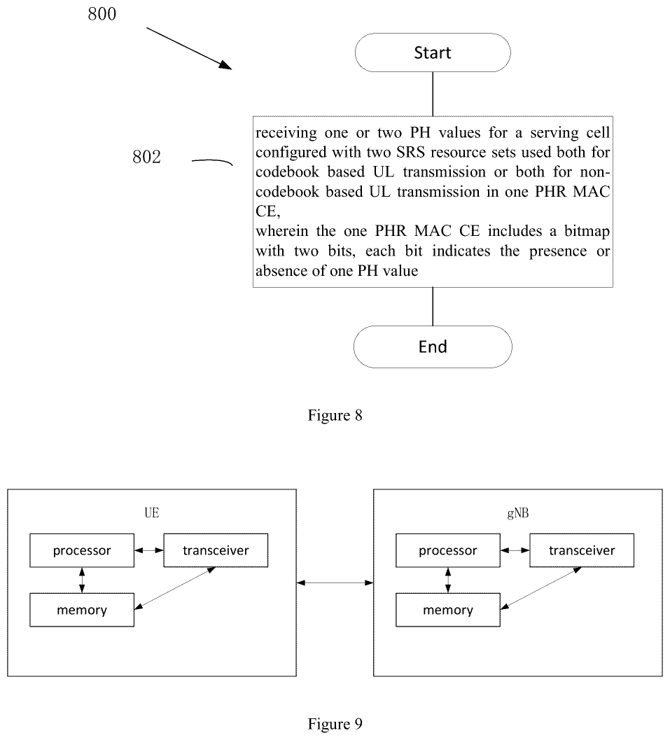

FIG. 8 is a schematic flow chart diagram illustrating an embodiment of a method 800 according to the present application. In some embodiments, the method 800 is performed by an apparatus, such as a base unit. In certain embodiments, the method 800 may be performed by a processor executing program code, for example, a microcontroller, a microprocessor, a CPU, a GPU, an auxiliary processing unit, a FPGA, or the like.

The method 800 may include 802 receiving one or two PH values for a serving cell configured with two SRS resource sets used both for codebook based UL transmission or both for non-codebook based UL transmission in one PHR MAC CE, wherein the one PHR MAC CE includes a bitmap with two bits, each bit indicates the presence or absence of one PH value.

The one PHR MAC CE may be a Single Entry PHR MAC CE or a Multiple Entry PHR MAC CE.

FIG. 9 is a schematic block diagram illustrating apparatuses according to one embodiment.

Referring to FIG. 9, the UE (i.e. the remote unit) includes a processor, a memory, and a transceiver. The processor implements a function, a process, and/or a method which are proposed in FIG. 7.

The UE comprises a processor that determines one or two PH values when power headroom report triggering condition is satisfied for a serving cell configured with two SRS resource sets used both for codebook based UL transmission or both for non-codebook based UL transmission; and a transmitter that transmits the determined one or two PH values for the serving cell in one PHR MAC CE. The serving cell has two TRPs, where each of the two SRS resource sets used both for codebook based UL transmission or both for non-codebook based UL transmission corresponds to a different one of the two TRPs.

In one embodiment, the power headroom report triggering condition is satisfied if a deactivated UE panel is activated, and one PH value corresponding to the activated UE panel is determined.

In another embodiment, a first phr-PeriodicTimer and a second phr-PeriodicTimer are configured on the serving cell, the first phr-PeriodicTimer is associated with a first TRP of the two TRPs, and the second phr-PeriodicTimer is associated with a second TRP of the two TRPs, when the first phr-PeriodicTimer expires, the PH value corresponding to the first TRP is determined, and when the second phr-PeriodicTimer expires, the PH value corresponding to the second TRP is determined. Alternatively, one phr-PeriodicTimer is configured on the serving cell, when the one phr-PeriodicTimer expires, two PH values corresponding to the two TRPs of the serving cell are determined.

In some embodiment, a phr-ProhibitTimer is configured on the serving cell, the first phr-Tx-PowerFactorChange is associated with a first PL-RS group, and the second phr-Tx-PowerFactorChange is associated with a second PL-RS group, when the phr-ProhibitTimer expires or has expired, and the pathloss measured within the first PL-RS group has changed more than the first phr-Tx-PowerFactorChange since the last transmission of the PH value corresponding to a first TRP of the two TRPs, the PH value corresponding to the first TRP is determined, and when the phr-ProhibitTimer expires or has expired, and the pathloss measured within the second PL-RS group has changed more than the second phr-Tx-Power FactorChange since the last transmission of the PH value corresponding to a second TRP of the two TRPs, the PH value corresponding to the second TRP is determined. Alternatively, a phr-ProhibitTimer is configured on the serving cell, a phr-Tx-PowerFactorChange is configured, the phr-Tx-PowerFactorChange is associated with both a first PL-RS group and a second PL-RS group, when the phr-ProhibitTimer expires or has expired, and the pathloss measured within the first PL-RS group has changed more than the phr-Tx-PowerFactorChange since the last transmission of the PH value corresponding to a first TRP of the two TRPs, the PH value corresponding to the first TRP is determined, and when the phr-ProhibitTimer expires or has expired, and the pathloss measured within the second PL-RS group has changed more than the phr-Tx-PowerFactorChange since the last transmission of the PH value corresponding to a second TRP of the two TRPs, the PH value corresponding to the second TRP is determined.

In some embodiment, a phr-ProhibitTimer is configured on the serving cell, a phr-Tx-PowerFactorChange is configured, when phr-ProhibitTimer expires or has expired, if the MAC entity has UL resources for new transmission with multi-beam repetition, and if the required power backoff due to power management corresponding to either a first TRP or a second TRP of the two TRPs has changed more than phr-Tx-Power FactorChange since the last transmission of the PH value(s) when the MAC entity had UL resources for transmission with multi-beam repetition on at least one of the first TRP and the second TRP, the PH value corresponding to the first TRP and the PH value corresponding to the first TRP are determined. If one PH value was determined the last time, the one PH value is a reference PH value to be compared with the required power backoff due to power management: and if two PH values were determined the last time, one of the two PH values is determined as the reference PH value to be compared with the required power backoff due to power management. Alternatively, a phr-ProhibitTimer is configured on the serving cell, a first phr-Tx-PowerFactorChange and a second phr-Tx-PowerFactorChange are configured, when the phr-ProhibitTimer expires or has expired, if the MAC entity has UL resources for new transmission with multi-beam repetition, and if the required power backoff due to power management corresponding to a first TRP of the two TRPs has changed more than the first phr-Tx-PowerFactorChange since the last transmission of the PH value corresponding to the first TRP when the MAC entity had UL resources for transmission with multi-beam repetition on the first TRP, the PH value corresponding to the first TRP is determined, and when the phr-ProhibitTimer expires or has expired, if the MAC entity has UL resources for new transmission with multi-beam repetition, if the required power backoff due to power management corresponding to a second TRP of the two TRPs has changed more than the second phr-Tx-PowerFactorChange since the last transmission of the PH value corresponding to the second TRP when the MAC entity had UL resources for transmission with multi-beam repetition on the second TRP, the PH value corresponding to the second TRP is determined. Further alternatively, a phr-ProhibitTimer is configured on the serving cell, a phr-Tx-PowerFactorChange is configured, when the phr-ProhibitTimer expires or has expired, if the MAC entity has UL resources for new transmission with multi-beam repetition, and if the required power backoff due to power management corresponding to a first TRP of the two TRPs has changed more than the phr-Tx-PowerFactorChange since the last transmission of the PH value corresponding to the first TRP when the MAC entity had UL resources for transmission with multi-beam repetition on the first TRP, the PH value corresponding to the first TRP is determined, and when the phr-ProhibitTimer expires or has expired, if the MAC entity has UL resources for new transmission with multi-beam repetition, if the required power backoff due to power management corresponding to a second TRP of the two TRPs has changed more than the phr-Tx-PowerFactorChange since the last transmission of the PH value corresponding to the second TRP when the MAC entity had UL resources for transmission with multi-beam repetition on the second TRP, the PH value corresponding to the second TRP is determined.

In some embodiment, the one PHR MAC CE is a Single Entry PHR MAC CE that includes a bitmap with two bits, the i^{th} bit indicates the presence of a PH field for the i^{th} TRP of the serving cell, i is from 1 to 2. Alternatively, the one PHR MAC CE is a Multiple Entry PHR MAC CE that includes a bitmap with two bits, the i^{th} bit indicates the presence of a PH field for the i^{th} TRP of the serving cell, i is from 1 to 2.

The gNB (i.e. the base unit) includes a processor, a memory, and a transceiver. The processor implements a function, a process, and/or a method which are proposed in FIG. 8.

The base unit comprises a receiver that receives one or two PH values for a serving cell configured with two SRS resource sets used both for codebook based UL transmission or both for non-codebook based UL transmission in one PHR MAC CE, wherein the one PHR MAC CE includes a bitmap with two bits, each bit indicates the presence or absence of one PH value.

The one PHR MAC CE may be a Single Entry PHR MAC CE or a Multiple Entry PHR MAC CE.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A method of a user equipment (UE), comprising:
determining one or two power headroom (PH) values when a power headroom report triggering condition is satisfied for a serving cell configured with two sounding reference signal (SRS) resource sets used both for codebook based uplink (UL) transmission or both for non-codebook based UL transmission; and
transmitting the determined one or two PH values for the serving cell in one power headroom report (PHR) medium access control (MAC) control element (CE).

2. The method of claim 1, wherein the serving cell has two transmission reception points (TRPs), and each of the two SRS resource sets used both for codebook based UL transmission or both for non-codebook based UL transmission corresponds to a different one of the two TRPs.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A user equipment (UE) for wireless communication, comprising:
at least one memory; and
at least one processor coupled with the at least one memory and configured to cause the UE to:
determine one or two power headroom (PH) values when a power headroom report triggering condition is satisfied for a serving cell configured with two sounding reference signal (SRS) resource sets used both for codebook based uplink (UL) transmission or both for non-codebook based UL transmission; and
transmit the determined one or two PH values for the serving cell in one power headroom report (PHR) medium access control (MAC) control element (CE).

15. A base station for wireless communication, comprising:
at least one memory; and
at least one processor coupled with the at least one memory and configured to cause the base station to:
receive one or two power headroom (PH) values for a serving cell configured with two sounding reference signal (SRS) resource sets used both for codebook based uplink (UL) transmission or both for non-codebook based UL transmission in one power headroom report (PHR) medium access control (MAC) control element (CE),
wherein the one PHR MAC CE includes a bitmap with two bits, and each bit indicates a presence or absence of one PH value.

16. The UE of claim 14, wherein the serving cell has two transmission reception points (TRPs), and each of the two SRS resource sets used both for codebook based UL transmission or both for non-codebook based UL transmission corresponds to a different one of the two TRPs.

17. The UE of claim 16, wherein,
the power headroom report triggering condition is satisfied if a deactivated UE panel is activated, and
one PH value corresponding to the activated UE panel is determined.

18. The UE of claim 16, wherein,
a first phr-PeriodicTimer and a second phr-PeriodicTimer are configured on the serving cell,
the first phr-PeriodicTimer is associated with a first TRP of the two TRPs, and the second phr-PeriodicTimer is associated with a second TRP of the two TRPs,
when the first phr-Periodic Timer expires, a PH value corresponding to the first TRP is determined, and
when the second phr-PeriodicTimer expires, a PH value corresponding to the second TRP is determined.

19. The UE of claim 16, wherein,
one phr-PeriodicTimer is configured on the serving cell,
when the one phr-PeriodicTimer expires, two PH values corresponding to the two TRPs of the serving cell are determined.

20. The UE of claim 16, wherein,
a phr-ProhibitTimer is configured on the serving cell, a first phr-Tx-PowerFactorChange and a second phr-Tx-PowerFactorChange are configured,
the first phr-Tx-PowerFactorChange is associated with a first pathloss reference signal (PL-RS) group, and the second phr-Tx-PowerFactorChange is associated with a second PL-RS group,
when the phr-ProhibitTimer expires or has expired, and a pathloss measured within the first PL-RS group has changed more than the first phr-Tx-PowerFactorChange since a last transmission of a PH value corresponding to a first TRP of the two TRPs, a PH value corresponding to the first TRP is determined, and
when the phr-ProhibitTimer expires or has expired, and a pathloss measured within the second PL-RS group has changed more than the second phr-Tx-PowerFactorChange since the last transmission of the PH value corresponding to a second TRP of the two TRPs, a PH value corresponding to the second TRP is determined.

21. The UE of claim 16, wherein,
a phr-ProhibitTimer is configured on the serving cell,
a phr-Tx-PowerFactorChange is configured,
the phr-Tx-PowerFactorChange is associated with both a first pathloss reference signal (PL-RS) group and a second PL-RS group,
when the phr-ProhibitTimer expires or has expired, and a pathloss measured within the first PL-RS group has changed more than the phr-Tx-PowerFactorChange since a last transmission of the PH value corresponding to a first TRP of the two TRPs, a PH value corresponding to the first TRP is determined, and
when the phr-ProhibitTimer expires or has expired, and a pathloss measured within the second PL-RS group has changed more than the phr-Tx-PowerFactorChange since a last transmission of the PH value corresponding to a second TRP of the two TRPs, a PH value corresponding to the second TRP is determined.

22. The UE of claim 16, wherein,
a phr-ProhibitTimer is configured on the serving cell,
a phr-Tx-PowerFactorChange is configured,
when phr-ProhibitTimer expires or has expired, if a MAC entity has UL resources for new transmission with multi-beam repetition, and if a required power backoff due to power management corresponding to either a first TRP or a second TRP of the two TRPs has changed more than phr-Tx-PowerFactorChange since a last transmission of the one or two PH values when the MAC entity had UL resources for transmission with multi-beam repetition on at least one of the first TRP and the second TRP, a PH value corresponding to the first TRP and a PH value corresponding to the first TRP are determined.

23. The UE of claim 22, wherein, if one PH value was determined a last time, the one PH value is a reference PH value to be compared with the required power backoff due to power management; and if two PH values were determined the last time, one of the two PH values is determined as the reference PH value to be compared with the required power backoff due to power management.

24. The UE of claim 16, wherein,
a phr-ProhibitTimer is configured on the serving cell,
a first phr-Tx-PowerFactorChange and a second phr-Tx-PowerFactorChange are configured,
when the phr-ProhibitTimer expires or has expired, if a MAC entity has UL resources for new transmission with multi-beam repetition, and if a required power backoff due to power management corresponding to a first TRP of the two TRPs has changed more than the first phr-Tx-PowerFactorChange since a last transmission of a PH value corresponding to the first TRP when the MAC entity had UL resources for transmission with multi-beam repetition on the first TRP, the PH value corresponding to the first TRP is determined, and
when the phr-ProhibitTimer expires or has expired, if the MAC entity has UL resources for new transmission with multi-beam repetition, if the required power backoff due to power management corresponding to a second TRP of the two TRPs has changed more than the second phr-Tx-PowerFactorChange since a last transmission of the PH value corresponding to the second TRP when the MAC entity had UL resources for transmission with multi-beam repetition on the second TRP, the PH value corresponding to the second TRP is determined.

25. The UE of claim 16, wherein,
a phr-ProhibitTimer is configured on the serving cell,
a phr-Tx-PowerFactorChange is configured,
when the phr-ProhibitTimer expires or has expired, if a MAC entity has UL resources for new transmission with multi-beam repetition, and if a required power backoff due to power management corresponding to a first TRP of the two TRPs has changed more than the phr-Tx-PowerFactorChange since a last transmission of the PH value corresponding to the first TRP when the MAC entity had UL resources for transmission with multi-beam repetition on the first TRP, the PH value corresponding to the first TRP is determined, and
when the phr-ProhibitTimer expires or has expired, if the MAC entity has UL resources for new transmission with multi-beam repetition, if the required power backoff due to power management corresponding to a second TRP of the two TRPs has changed more than the phr-Tx-PowerFactorChange since a last transmission of the PH value corresponding to the second TRP when the MAC entity had UL resources for transmission with multi-beam repetition on the second TRP, the PH value corresponding to the second TRP is determined.

26. The UE of claim 16, wherein, the one PHR MAC CE is a Single Entry PHR MAC CE that includes a bitmap with two bits, an iₜₕ bit of the bitmap indicates presence of a PH field for an iₜₕ TRP of the serving cell, and i is from 1 to 2.

27. The UE of claim 16, wherein, the one PHR MAC CE is a Multiple Entry PHR MAC CE that includes a bitmap with two bits, an iₜₕ bit of the bitmap indicates presence of a PH field for an it TRP of the serving cell, and i is from 1 to 2.

28. A processor for wireless communication, comprising:
at least one controller coupled with at least one memory and configured to cause the processor to:
determine one or two power headroom (PH) values when a power headroom report triggering condition is satisfied for a serving cell configured with two sounding reference signal (SRS) resource sets used both for codebook based uplink (UL) transmission or both for non-codebook based UL transmission; and
transmit the determined one or two PH values for the serving cell in one power headroom report (PHR) medium access control (MAC) control element (CE).

29. The processor of claim 28 wherein the serving cell has two transmission reception points (TRPs), and each of the two SRS resource sets used both for codebook based UL transmission or both for non-codebook based UL transmission corresponds to a different one of the two TRPs.

30. The processor of claim 29, wherein,
the power headroom report triggering condition is satisfied if a deactivated user equipment (UE) panel of a UE that includes the processor is activated, and
one PH value corresponding to the activated UE panel is determined.

31. The processor of claim 29, wherein,
a first phr-Periodic Timer and a second phr-PeriodicTimer are configured on the serving cell,
the first phr-Periodic Timer is associated with a first TRP of the two TRPs, and the second phr-PeriodicTimer is associated with a second TRP of the two TRPs,
when the first phr-Periodic Timer expires, a PH value corresponding to the first TRP is determined, and
when the second phr-PeriodicTimer expires, a PH value corresponding to the second TRP is determined.
